(19) United States
(12) Patent Application Publication
(10) Pub. No.: US 2026/0035514 A1
(43) Pub. Date: Feb. 5, 2026

(54) ZWITTERIONIC POLYSILOXANES

(71) Applicant: Rudolf GmbH, Geretsried (DE)

(72) Inventors: Christoph BRUNNER, Eurasburg (DE); Rainer HAYESSEN, Geretsried (DE); Dirk SIELEMANN, Wolfratshausen (DE)

(73) Assignee: Rudolf GmbH, Geretsried (DE)

(21) Appl. No.: 19/282,234

(22) Filed: Jul. 28, 2025

(30) Foreign Application Priority Data
Aug. 2, 2024 (EP) 24192651.8

(51) Int. Cl. C08G 77/26; D06M 15/643; D06M 15/71; D06M 101/06

(52) U.S. Cl. CPC C08G 77/26; D06M 15/6433; D06M 15/71; D06M 2101/06; D06M 2200/50

(57) ABSTRACT

The present invention relates to polysiloxanes having zwitterionic groups, their preparation, compositions comprising such polysiloxanes and the use of these polysiloxanes or compositions for treating substrates.

### CROSS REFERENCE TO RELATED APPLICATIONS

This application claims priority and the benefit of European Patent Application No. 24192651.8, filed Aug. 2, 2024, the disclosures of which is incorporated herein by reference in its entirety.

### DESCRIPTION

The present invention relates to polysiloxanes having zwitterionic groups, their preparation, compositions comprising such polysiloxanes and the use of these polysiloxanes or compositions for treating substrates.

Polysiloxanes are used in a variety of ways for finishing textile materials. Due to their flexible structure and ease of functionalisation, they can be tailor-made for a number of different applications.

Amino-modified polysiloxanes have long been used as softening agents. They are usually applied to the textile as liquid preparations in the form of aqueous emulsions. The amino-modified polysiloxanes form stable emulsions in water at an acidic pH value with the addition of emulsifiers.

However, the formulations described have a number of disadvantages such as low stability under alkaline conditions, high sensitivity to salts and anions and poor resistance to shear stress during application on modern finishing machines. Another disadvantage is a pronounced thermal yellowing tendency of the treated substrates, especially at drying temperatures above 120° C.

However, many textile pre-treatment processes require the use of high pH values in the aqueous treatment baths. For example, the pretreatment, bleaching and dyeing of cellulose substrates always require the use of high quantities of alkali. If such process steps are not sufficiently neutralised and carefully washed out, alkaline components are carried over into the subsequent treatment baths with softening agents, which can result in destabilisation of emulsions of amino-functional polysiloxanes. The destabilisation of the emulsions under alkaline conditions is due to deprotonation of the amino-functional groups of the polysiloxane. Without the cationic charges on the polysiloxane, the microemulsion coagulates. The resulting coagulate is deposited heterogeneously on the textile to be treated and causes stains on the textile.

Emulsions of polysiloxanes, which carry quaternary ammonium groups, can at least partially overcome the disadvantages described. The production of diquaternary polysiloxanes is described, for example, in U.S. Pat. No. 4,891,166. They are synthesised by reacting polysiloxanes bearing terminal epoxide groups with tertiary amines in such proportions that each epoxide group corresponds to at least one tertiary amino group. The reaction is carried out at elevated temperature in the presence of an acid equivalent relative to the nitrogen atoms to be quaternised. The resulting diquaternary polysiloxanes have only terminally positioned quaternary ammonium groups due to this special production method. The compounds produced in this way are recommended for use in hair treatment products and cosmetics.

Ammonium- and polyether-modified polysiloxanes are described in DE 10 2005 056 864 B4. The polysiloxanes are produced from an epoxy-functional polysiloxane that is reacted with amines and alkyl alcohol alkoxylates. This is followed by quaternisation with an alkylating agent. The polysiloxanes are used to finish textile substrates and are characterised by high thermal yellowing resistance. Due to the terminal polyether and ammonium groups, they also have good pH stability.

However, the above-mentioned advantages of polysiloxanes containing quaternary ammonium groups are offset under practical conditions by the disadvantage that they often show a lack of resistance to phenolic yellowing, to anionic textile auxiliaries and to salt addition as well as to shearing effects, particularly in jet processes, in the presence of anions and salt addition.

In jet dyeing machines, the finishing agents are subjected to strong dynamic loads due to high shear forces, which destabilise the treatment agents and—as described above—can lead to undesirable stain formation.

In the softening finishing of dyed or optically brightened fabric in jet dyeing machines in which the fabric has already been dyed or optically brightened, it is important on the one hand that there is no undesirable separation from the destabilised softening emulsion and on the other hand that the respective dyeing or optical brightening is not impaired.

The task is therefore to provide improved polysiloxanes for soft handle finishing which fulfil these requirements and overcome the disadvantages of the prior art. In particular, polysiloxanes should be provided which have a high emulsion stability against anions, salts, pH changes and strong shear forces as well as combinations of these influencing factors and are resistant to thermal and phenolic yellowing.

Surprisingly, this task is solved by the polysiloxanes according to the invention, which are modified with zwitterionic groups.

Surprisingly, it has been shown that the zwitterionic polysiloxanes according to the invention and emulsions thereof exhibit high shear stability, particularly in the presence of salts, stability to anions and resistance to phenolic yellowing. The polysiloxanes according to the invention are not only suitable as softening agents, but can also be added to paints, glazes, lacquers and car care products, for example to improve their wetting, spreading and/or levelling properties.

A first aspect of the invention therefore relates to a polysiloxane of the general formula A

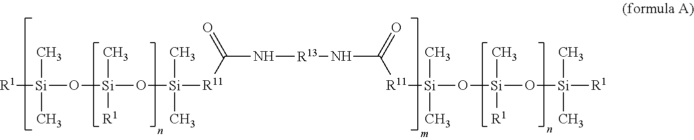

wherein
R¹ is independently of each other
   methyl,

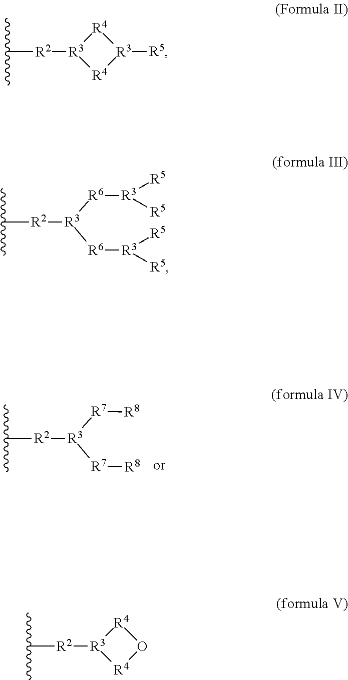

with the proviso that in formula A at least one R¹ corresponds to one of formulae II-V,
R² is independently of each other

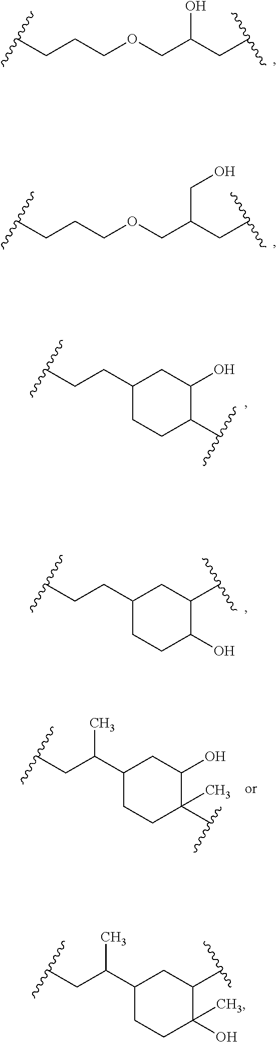 [SMILES: *CCCOCC(O)C* ; *CCCOCC(C*)CO ; *CCC1CCC(*)C(O)C1 ; *CCC1CCC(O)C(*)C1 ; *CC(C)C1CCC(*)(C)C(O)C1 ; *CC(C)C1CCC(C)(O)C(*)C1]

R³ is independently of each other

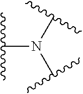 [SMILES: *N(*)*]

or a zwitterionic group selected from

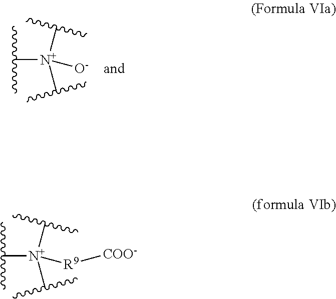

with the proviso that at least one R³ in formula A is a zwitterionic group,
R⁴ is independently of each other an unbranched or branched C₁₋₇-alkylene, preferably an unbranched C₁₋₅-alkylene, particularly preferably —(CH₂)₂—,
R⁵ is independently of each other a branched or unbranched C₁₋₁₈-alkyl, preferably an unbranched C₁₋₈-alkyl, particularly preferably methyl,
R⁶ is independently of each other an unbranched C₂-s-alkylene, preferably
   is —(CH₂)₂— or —(CH₂)₃—,
R⁷ is independently of each other an unbranched or branched C₁₋₁₈-alkylene, preferably an unbranched C₁₋₈-alkylene, particularly preferably —(CH₂)₂— or methylene,
R³ is independently H or OH,
R⁹ is independently of each other an unbranched or branched C₁₋₁₈-alkylene, preferably an unbranched C₁₋₈-alkylene, particularly preferably methylene,
R¹¹ is independently of each other

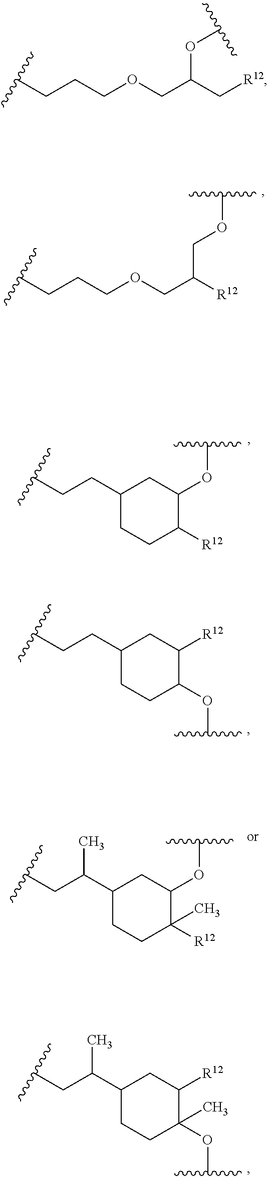

R¹² is independently of each other

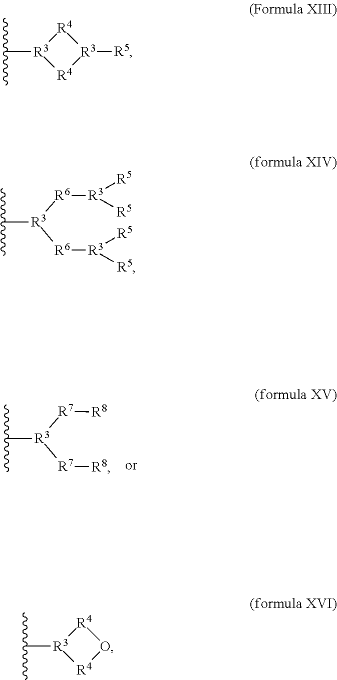

R¹³ is independently of each other an aliphatic or cyclic C₁₋₁₈-alkylene or arylene, in each case optionally substituted by C₁₋₈-alkyl or benzyl, preferably unbranched C₁₋₈-alkylene, in particular —(CH₂)₄—, —(CH₂)₆—,

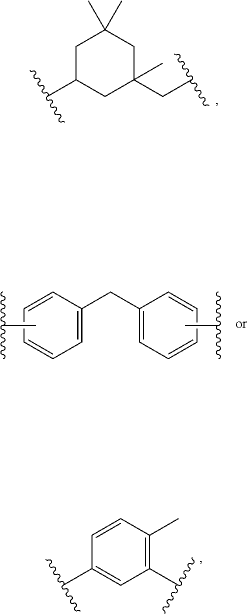

n is an integer from 20-2,000, preferably 40-1,000, particularly preferably 40-180, and
m is 0 or an integer greater than 0, preferably 0 or 1-2,000, particularly preferably 0 or 1-55.

Preferably, 0-99.9%, more preferably 50-99.9%, even more preferably 80-99.9% and particularly preferably 90-99.9% of the R¹ substituents are methyl in the polysiloxane according to the invention.

Alternatively, preferably 0-99.999%, more preferably 50-99.999%, even more preferably 80-99.999% and particularly preferably 90-99.999% of the R¹ substituents are methyl in the polysiloxane according to the invention.

The zwitterionic embodiments of the R¹ substituent according to formulae II-V can be positioned terminally and/or laterally on the polysiloxane backbone in the polysiloxane according to the invention.

In a preferred embodiment, in the polysiloxane according to the invention, the two terminal R¹ substituents are methyl and at least one lateral R¹ substituent corresponds to one of formulae II-V.

In an alternative embodiment, in the polysiloxane according to the invention, all lateral R¹ substituents are methyl and the two terminal R¹ substituents are selected from formulae II-V.

In a preferred embodiment, all R¹ substituents of the polysiloxane according to the invention are selected from methyl and formulae II, III and V.

In a preferred embodiment, all R¹ substituents of the polysiloxane according to the invention are selected from methyl and formula II.

In an alternative embodiment, all R¹ substituents of the polysiloxane according to the invention are selected from methyl and formula III.

If at least one R¹ substituent in the polysiloxane according to the invention corresponds to formula IV, R³ is preferably OH.

If at least one R¹² substituent in the polysiloxane according to the invention corresponds to formula XV, R³ is preferably OH.

It is preferred that 10-100%, more preferably 40-99.9%, particularly preferably 50-95% and most preferably 60-80% of R³ in the polysiloxane according to the invention are present as zwitterionic groups. It has surprisingly been shown that polysiloxanes according to the invention already exhibit improved process stability compared to polysiloxanes without zwitterionic groups if at least 10% of the R³ substituents are present as zwitterionic groups. An even better emulsion stability in the application, in particular against shear forces, especially in the presence of salts, against anions and resistance to phenolic yellowing is achieved if 50-100%, preferably 60-100% of the R³ substituents are present as zwitterionic groups.

In a preferred embodiment, all zwitterionic groups in the polysiloxane according to the invention are present as formula VIa.

In an alternative embodiment, all zwitterionic groups in the polysiloxane according to the invention are present as formula VIb.

Preferably, R² in the polysiloxane according to the invention corresponds to the formulae

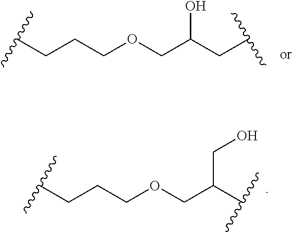 [SMILES: *CCCOCC(O)C* ; *CCCOCC(*)CO]

In a preferred embodiment, in the polysiloxane of formula A
R¹ is independently of each other
   methyl,

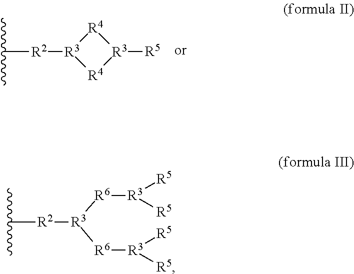

with the proviso that in formula A at least one R¹ corresponds to one of the formulae II-III,
R² is independently of each other

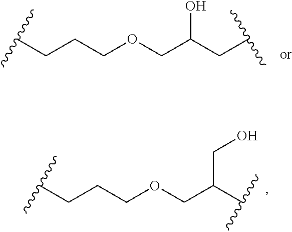 [SMILES: *CCCOCC(O)C* ; *CCCOCC(*)CO]

and
R³ is independently of each other

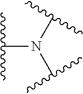 [SMILES: *N(*)*]

or a zwitterionic group selected from

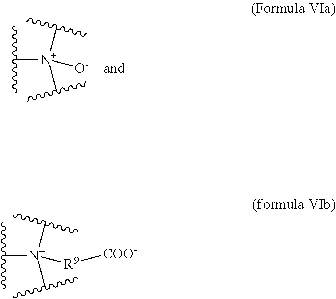

with the proviso that at least one R³ in formula A is a zwitterionic group,
R¹¹ is independently of each other

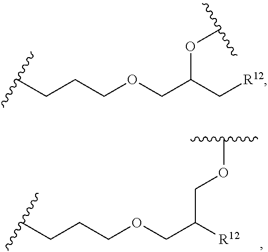

R¹² is independently of each other

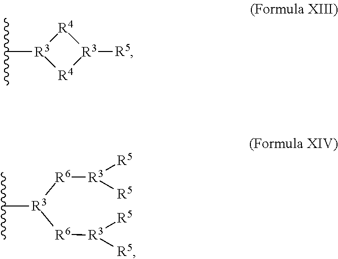

R⁴, R⁵, R⁶, R⁹, R¹³, m and n are as defined above.

In a preferred embodiment, substantially all of the lateral R¹ substituents are methyl, in particular 90-99.999% of the R¹ substituents are methyl if m is greater than 0.

In a preferred embodiment m=0, i.e. the polysiloxane corresponds to formula I

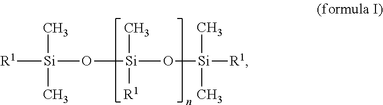

wherein
R¹ is independently of each other
   methyl,

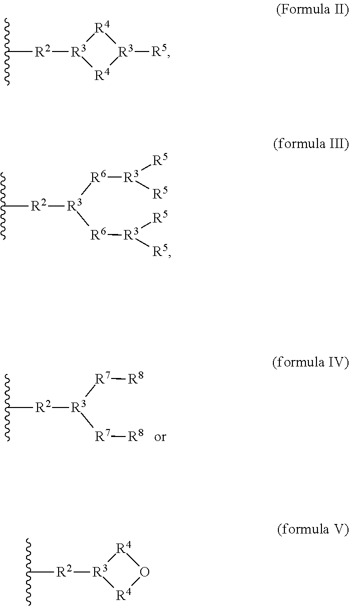

with the proviso that in formula I at least one R¹ corresponds to one of formulae II-V,
R² is independently of each other

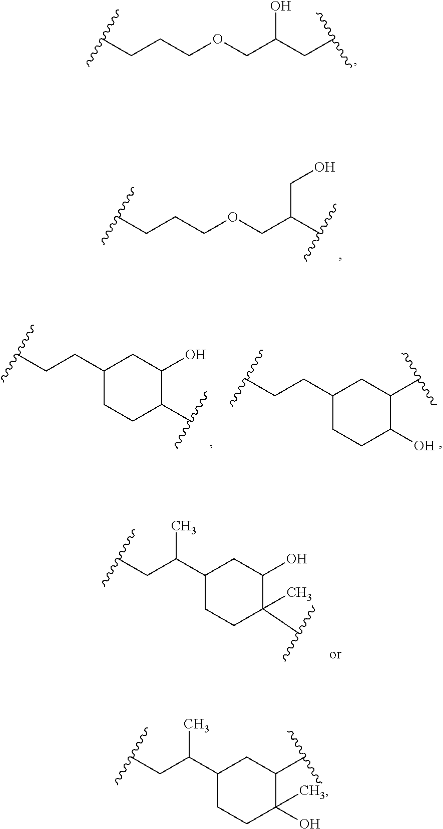 [SMILES: *CCCOCC(O)C* ; *CCCOCC(*)CO ; *CCC1CCC(*)C(O)C1 ; *CCC1CCC(O)C(*)C1 ; *CC(C)C1CCC(*)(C)C(O)C1 ; *CC(C)C1CCC(C)(O)C(*)C1]

R³ is independently of each other

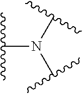 [SMILES: *N(*)*]

or a zwitterionic group selected from

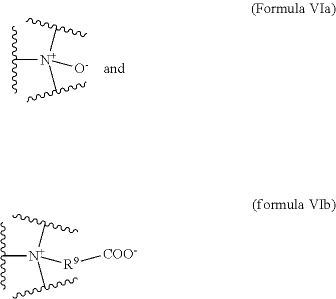

with the proviso that at least one R³ in formula I is a zwitterionic group,
R⁴ is independently of each other an unbranched or branched C₁₋₇-alkylene, preferably an unbranched C₁₋₅-alkylene, particularly preferably —(CH₂)₂—,
R⁵ is independently of each other a branched or unbranched C₁₋₁₈-alkyl, preferably an unbranched C₁₋₈-alkyl, particularly preferably methyl,
R⁶ is independently of each other an unbranched C₂-s-alkylene, preferably
   is —(CH₂)₂— or —(CH₂)₃—,
R⁷ is independently of each other an unbranched or branched C₁₋₁₈-alkylene, preferably an unbranched C₁₋₈-alkylene, particularly preferably —(CH₂)₂— or methylene,
R⁸ is independently H or OH,
R⁹ is independently of each other an unbranched or branched C₁₋₁₈-alkylene, preferably an unbranched C₁₋₈-alkylene, particularly preferably methylene, and
n is an integer from 20-2,000, preferably 40-1000, particularly preferably 40-180.

Preferably, 0-99.9%, more preferably 50-99.9%, even more preferably 80-99.9% and particularly preferably 90-99.9% of the R¹ substituents in the polysiloxane according to the invention are methyl.

In the polysiloxane according to the invention, the zwitterionic embodiments of the R¹ substituents according to formulae II-V can be positioned terminally and/or laterally on the polysiloxane backbone.

In a preferred embodiment, the two terminal R¹ substituents in the polysiloxane according to the invention are methyl and at least one lateral R¹ substituent corresponds to one of formulae II-V.

In an alternative embodiment, in the polysiloxane according to the invention, all lateral R¹ substituents are methyl and the two terminal R¹ substituents are selected from formulae II-V.

In a preferred embodiment, all R¹ substituents of the polysiloxane according to the invention are selected from methyl and formulae II, III and V.

In a preferred embodiment, all R¹ substituents of the polysiloxane according to the invention are selected from methyl and formula II.

In an alternative embodiment, all R¹ substituents of the polysiloxane according to the invention are selected from methyl and formula III.

If at least one R¹ substituent in the polysiloxane according to the invention corresponds to formula IV, R³ is preferably OH.

It is preferred that 10-100%, more preferably 40-99.9%, particularly preferably 50-95% and most preferably 60-80% of R³ in the polysiloxane according to the invention are present as zwitterionic groups. It has surprisingly been shown that polysiloxanes according to the invention already exhibit improved process stability compared to polysiloxanes without zwitterionic groups if at least 10% of the R³ substituents are present as zwitterionic groups. An even better emulsion stability in the application, in particular against shear forces, especially in the presence of salts, against anions and resistance to phenolic yellowing is achieved if 50-100%, preferably 60-100% of the R³ substituents are present as zwitterionic groups.

In a preferred embodiment, all zwitterionic groups in the polysiloxane according to the invention are present as formula VIa.

In an alternative embodiment, all zwitterionic groups in the polysiloxane according to the invention are present as formula VIb.

Preferably, R² in the polysiloxane according to the invention corresponds to the formulae

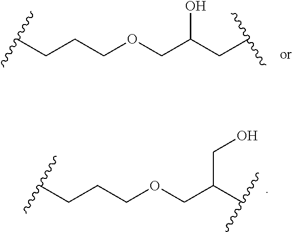 [SMILES: *CCCOCC(O)C* ; *CCCOCC(*)CO]

In a preferred embodiment, in the polysiloxane of formula I
R¹ is independently of each other
   methyl,

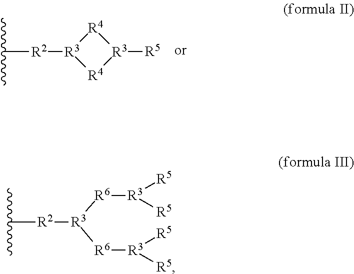

with the proviso that in formula I at least one R¹ corresponds to one of formulae II-III,
R² independently of each other

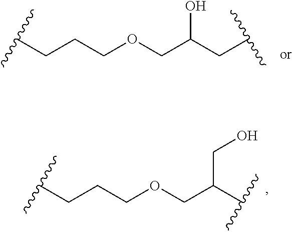 [SMILES: *CCCOCC(O)C* ; *CCCOCC(*)CO]

and
R³ is independently of each other

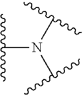 [SMILES: *N(*)*]

or a zwitterionic group selected from

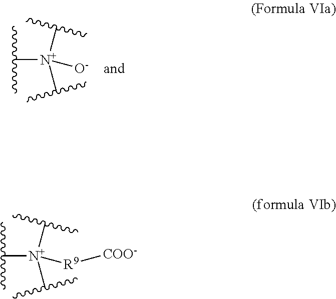

with the proviso that at least one R³ in formula I is a zwitterionic group.

R⁴, R⁵, R⁶, R⁹ and n are as defined above.

Another aspect of the invention comprises a process for preparing polysiloxanes according to the invention, comprising
(a) providing a polysiloxane of the general formula VII

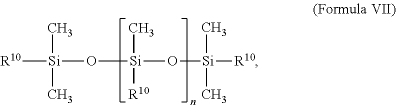

wherein
   R¹⁰ is independently of each other
      methyl,

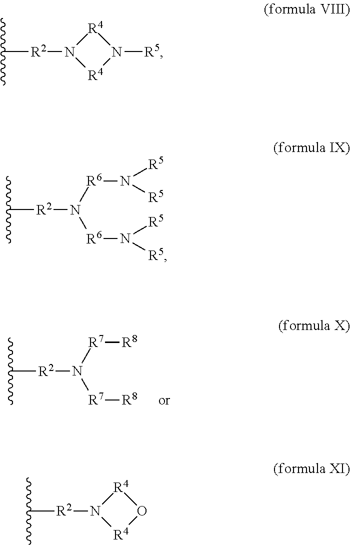

with the proviso that in formula VII at least one R¹⁰ corresponds to one of formulae VIII-XI,
(b) optionally reacting the polysiloxane of the general formula VII with a diisocyanate of the formula OCN—R¹³—NCO, and
(c) reacting the polysiloxane of formula VII or the polysiloxane adduct obtained after step (b) with a reactant selected from a peroxide and/or a compound of the general formula XII

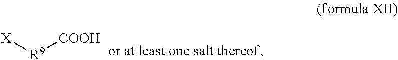

wherein X is a halogen, in particular Cl or Br,
   and wherein the peroxide is preferably hydrogen peroxide (H₂O₂), di-tert-butyl peroxide, tert-butyl hydroperoxide, tert-butyl peroxybenzoate, meta-chloroperbenzoic acid, dibenzoyl peroxide, diacetyl peroxide, peroxide of the formula diacetyl peroxide, peroxyacetic acid, dicumyl peroxide, cumene hydroperoxide, methyl ethyl ketone peroxide, sodium peroxide and/or barium peroxide and particularly preferably hydrogen peroxide (H₂O₂).

R², R⁴, R⁵, R⁶, R⁷, R⁸, R⁹, R¹³, n and m are as defined above.

Preferably, in step b) of the process according to the invention, the molar ratio of diisocyanate of the general formula OCN—R¹³—NCO to polysiloxane of the general formula VII is from 0.1:1-1:1, more preferably from 0.4:1-0.999:1, particularly preferably from 0.5:1-0.95:1 and most preferably from 0.6:1-0.9:1.

Preferably, in step b) of the process according to the invention, the molar ratio of the isocyanate groups of the diisocyanate of the general formula OCN—R¹³—NCO to the isocyanate-reactive hydroxy groups of the polysiloxane of the general formula VII is 0.1:1-1:1, more preferably 0.4:1-0.999:1, particularly preferably 0.5:1-0.95:1 and most preferably 0.6:1-0.9:1.

Preferably, in step b), the diisocyanate of the general formula OCN—R¹³—NCO is selected from the group consisting of toluene-2,4-diisocyanate, 2,4′-diphenylmethane diisocyanate, 4,4′-diphenylmethane diisocyanate (MDI), higher-chain homologues of diphenylmethane diisocyanate (polymeric MDI), tetramethylene diisocyanate, hexamethylene diisocyanate and/or isophorone diisocyanate.

Preferably, step b) is carried out using a solvent or in the absence of a solvent, more preferably in the absence of a solvent.

Preferably, step b) is carried out using a catalyst, in particular based on a tertiary amine, a bismuth compound and/or an organotin compound.

Preferably, the course of the reaction in step b) can be monitored titrimetrically or by IR spectroscopy.

If a salt of a halocarboxylic acid according to formula XII is used as reactant in step c), the salt is preferably the ammonium or sodium salt of the halocarboxylic acid.

Preferably, in the process according to the invention, the reactant is used in such an amount that the molar ratio between the reactant and the tertiary amino groups in the polysiloxane of formula VII or in the polysiloxane adduct obtained after step (b) corresponds to the desired degree of conversion of the amino groups to zwitterionic groups. Preferred is a molar ratio between reactant and the tertiary amino groups in the polysiloxane of formula VII of 0.1:1-1:1, more preferably 0.4:1-0.999:1, particularly preferably 0.5:1-0.95:1 and most preferably 0.6:1-0.8:1.

Preferably, the reaction in step b) and/or step c) of the process according to the invention is carried out at 15-150° C., more preferably at 20-105° C., even more preferably at 25-95° C., even more preferably at 40-90° C. and most preferably at 70-85° C.

Step c) of the process according to the invention is preferably carried out in a solvent, which particularly preferably comprises water and/or at least one organic solvent. Organic solvents can preferably be selected from the group of mono- and polyfunctional alcohols, e.g. ethanol, 1-propanol, 2-propanol, butanol, 2-methyl-2-propanol, 3-methyl-1-butanol and 2-hexyl-1-decanol and/or ether compounds thereof, e.g. ethylene glycol monomethyl ether, diethylene glycol dimethyl ether, diethylene glycol, dipropylene glycol-n-butyl ether, propylene glycol monobutyl ether, propylene glycol-n-butyl ether, dipropylene glycol monomethyl ether, dipropylene glycol dimethyl ether, hexylene glycol, butyl glycol, butyl diglycol, triethylene glycol dimethyl ether, and/or ketones, e.g. acetone, can be used. Preferably, the solvent is water and/or an organic solvent.

If necessary, further steps can be added to the process, such as distillation and/or filtration.

The preparation of the aminofunctional polysiloxanes of formula VII, which serve as starting compounds in the process according to the invention, is carried out according to methods known to the skilled person. Thus, in a first step, epoxy-functional polysiloxanes can be obtained by hydrosilylation of Si—H-containing polysiloxanes with α,β-unsaturated epoxy compounds. A corresponding process is described, for example, in DE 37 05 121 A1.

In the second step, the epoxide group is reacted with a secondary amine to form polysiloxanes of formula VII. A corresponding process is described, for example, in WO 02/10256 A1. If necessary, this can be followed by equilibration, for example with octamethylcyclotetrasiloxane.

In a further aspect, the invention relates to a polysiloxane obtainable by the process according to the invention described above.

In a preferred embodiment, the invention relates to a process for the preparation of polysiloxanes according to the invention, wherein a polysiloxane of the general formula VII

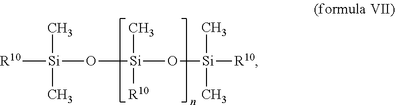

wherein
R¹⁰ is independently of each other
   methyl,

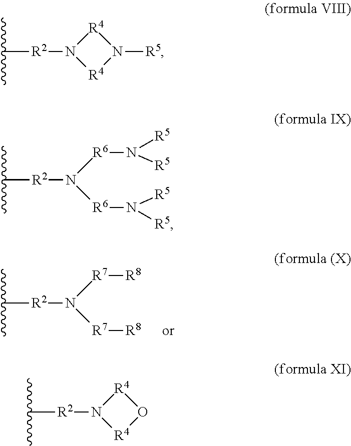

with the proviso that in formula VII at least one R¹⁰ corresponds to one of the formulae VIII-XI,
with a reactant selected from a peroxide and/or a compound of the general formula XII

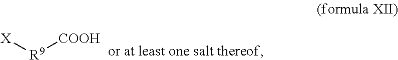

wherein X is a halogen, in particular Cl or Br,
and wherein the peroxide is preferably hydrogen peroxide (H₂O₂), di-tert-butyl peroxide, tert-butyl hydroperoxide, tert-butyl peroxybenzoate, meta-chloroperbenzoic acid, dibenzoyl peroxide diacetyl peroxide, peroxyacetic acid, dicumyl peroxide, cumene hydroperoxide, methyl ethyl ketone peroxide, sodium peroxide and/or barium peroxide and particularly preferably hydrogen peroxide (H₂O₂),
is reacted.

R², R⁴, R⁵, R⁶, R⁷, R⁸, R⁹ and n are as defined above.

If a salt of a halocarboxylic acid according to formula XII is used as reactant, the salt is preferably the ammonium or sodium salt of the halocarboxylic acid.

Preferably, the reactant is used in the process according to the invention in such an amount that the molar ratio between the reactant and the tertiary amino groups in the polysiloxane of formula VII corresponds to the desired degree of conversion of the amino groups to zwitterionic groups. Preferred is a molar ratio between the reactant and the tertiary amino groups in the polysiloxane of formula VII of 0.1:1-1:1, more preferably 0.4:1-0.999:1, particularly preferably 0.5:1-0.95:1 and most preferably 0.6:1-0.8:1.

Preferably, in the process according to the invention, the reaction is carried out at 15-150° C., more preferably at 20-105° C., even more preferably at 25-95° C. and particularly preferably at 70-85° C.

The process according to the invention is preferably carried out in a solvent, which particularly preferably comprises water and/or at least one organic solvent. Organic solvents can preferably be selected from the group of mono- and polyfunctional alcohols, e.g. ethanol, 1-propanol, 2-propanol, butanol, 2-methyl-2-propanol, 3-methyl-1-butanol and 2-hexyl-1-decanol and/or their ether compounds, e.g. ethylene glycol monomethyl ether, diethylene glycol dimethyl ether, diethylene glycol, dipropylene glycol-n-butyl ether, propylene glycol monobutyl ether, propylene glycol-n-butyl ether, dipropylene glycol monomethyl ether, dipropylene glycol dimethyl ether, hexylene glycol, butyl glycol, butyl diglycol, triethylene glycol dimethyl ether, and/or ketones, e.g. acetone can be used. Preferably, the solvent is water and/or an organic solvent.

If necessary, further steps can be added to the process, such as distillation and/or filtration.

The preparation of the aminofunctional polysiloxanes of formula VII, which serve as starting compounds in the process according to the invention, is carried out according to methods known to the skilled person. Thus, in a first step, epoxy-functional polysiloxanes can be obtained by hydrosilylation of Si—H-containing polysiloxanes with α,β-unsaturated epoxy compounds. A corresponding process is described, for example, in DE 37 05 121 A1.

In the second step, the epoxide group is reacted with a secondary amine to form polysiloxanes of formula VII. A corresponding process is described, for example, in WO 02/10256 A1. If necessary, this can be followed by equilibration, for example with octamethylcyclotetrasiloxane.

In a further aspect, the invention relates to a polysiloxane obtainable by the process according to the invention described above.

A further aspect of the invention relates to a composition comprising
(i) at least one polysiloxane according to the invention and
(ii) a solvent, in particular water and/or an organic solvent, more preferably water.

Preferably, the composition according to the invention contains 0.005-99.9% by weight, more preferably 5-99% by weight, particularly preferably 10-90% by weight of component (i), based on its total mass.

In a preferred embodiment, the composition according to the invention further comprises (iii) at least one emulsifier. The emulsifier may be anionic, cationic, non-ionic or amphoteric; mixtures of such emulsifiers may also be used.

Preferably, the composition according to the invention contains at least one non-ionic emulsifier, particularly preferably ethoxylation products of aliphatic alcohols. Such ethoxylation products of aliphatic alcohols can be contained in pure form or as a mixture in the composition according to the invention. Advantageous are, for example, ethoxylation products of aliphatic C₆₋₂₂-alcohols and in particular aliphatic C₃₋₁₃-alcohols, which can be saturated, linear or preferably branched and which contain up to 50 ethylene oxide units attached. Particularly advantageous are, for example, ethoxylation products of isodecyl alcohol, isotridecyl alcohol or C₁₋₁₃-alcohols, each with 2-50 and in particular 5-25 attached ethylene oxide units per molecule.

In addition to pure ethoxylation products, alcohols of the composition mentioned whose alkylene oxide radical is composed of ethylene oxide and 1,2-propylene oxide in random or block-like distribution are also suitable.

Preferably, the composition according to the invention contains, based on component (i), 2-100 wt. %, more preferably 10-80 wt. %, particularly preferably 20-70 wt. % of an emulsifier (iii) or a mixture of emulsifiers.

If the solvent (ii) of the composition according to the invention contains an organic solvent, this is preferably polar or non-polar. Organic solvents selected from the group of mono- and polyfunctional alcohols, e.g. ethanol, 1-propanol, 2-propanol, butanol, 2-methyl-2-propanol, 3-methyl-1-butanol and 2-hexyl-1-decanol and/or their ether compounds, e.g. ethylene glycol monomethyl ether, diethylene glycol dimethyl ether, diethylene glycol, dipropylene glycol n-butyl ether, propylene glycol monobutyl ether, propylene glycol n-butyl ether, dipropylene glycol monomethyl ether, dipropylene glycol dimethyl ether, hexylene glycol, butylene glycol, butyl diglycol, triethylene glycol dimethyl ether, and/or their ester compounds, e.g. ethyl acetate, n-propyl acetate, isopropyl acetate, n-butyl acetate, isobutyl acetate, 1-methoxy-2-propyl acetate, dibasic esters or amyl acetate and/or ketones, e.g. acetone, methyl ethyl ketone, methyl propyl ketone, and/or saturated hydrocarbons, in particular petrol with 5 to 10 carbon atoms, more preferably petrol with 6 to 8 carbon atoms, such as petrol, hexane, heptane, octane, cyclohexane and cycloheptane, in particular n-pentane, n-hexane, n-heptane or n-octane, isoparaffin or petroleum ether are preferred. Preferably, the solvent is water and/or an organic solvent. A composition according to the invention may also contain a mixture of polar and apolar solvents.

In a preferred embodiment, the composition according to the invention further comprises (iv) at least one additive, for example a dilutant, e.g. a polyethylene glycol having a molecular weight of 200-10,000 g/mol and preferably 400-6,000 g/mol, and/or glycerol and/or urea and/or at least one acid, in particular an organic acid such as acetic acid or lactic acid. The stability of the composition can be further improved by protonating any tertiary amino groups present in the polysiloxane.

In a particularly preferred embodiment, the composition according to the invention comprises (i) at least one polysiloxane according to the invention,
(iii) a solvent, in particular water, and
(iv) (iii) at least one emulsifier.

In this case, the composition according to the invention is preferably an emulsion, in particular an o/w emulsion, or a liquor, in particular an aqueous liquor. The preparation of emulsions according to the invention is carried out according to methods known to the skilled person, for example at temperatures between 15 and 70° C.

Based on its total mass, the emulsion preferably comprises 5-60 wt. % and particularly preferably 10-40 wt. % of component (i). The liquor preferably contains 0.005-3.0 wt. %, particularly preferably 0.01-1.2 wt. % of component (i) based on its total mass.

In a particularly preferred embodiment, the composition according to the invention comprises (i) at least one polysiloxane according to the invention, (ii) a solvent, in particular water, and (iv) at least one additive, in particular an acid.

In a particularly preferred embodiment, the composition according to the invention comprises (i) at least one polysiloxane according to the invention, (ii) a solvent, in particular water, (iii) at least one emulsifier and (iv) at least one additive, in particular an acid.

In a further preferred embodiment, the composition according to the invention comprises (i) at least one polysiloxane according to the invention, (ii) a solvent, in particular water, (iii) at least one emulsifier and (iv) at least one additive, in particular an acid and/or at least one softening agent, preferably an organomodified polysiloxane.

Suitable softening agents are, for example, polysiloxanes with amino, quat, polyether and/or (poly)urethane groups and combinations thereof.

The organomodified polysiloxane is different from the polysiloxane according to formula A.

It has surprisingly been shown that the said compositions and in particular emulsions are particularly stable to shear forces, especially in the presence of salts, and to anions, and exhibit resistance to phenolic yellowing. This facilitates a homogeneous treatment of substrates and in particular a homogeneous finishing of textiles with these compositions. The high process stability is a great advantage, especially when finishing using the jet process, as high shear forces often act in addition to the other factors mentioned and this can have a strong destabilising effect on emulsions.

Without being bound by any theory, it is assumed that the zwitterionic groups in the polysiloxanes according to the invention contribute significantly to stabilisation against these influences.

A further aspect of the invention relates to the use of polysiloxanes according to the invention or a composition according to the invention for treating a substrate or as an additive in paint, glaze, varnish and/or car care formulations. Preferred substrates for use according to the invention are textile, leather, metal, glass, wood or plastic.

In a preferred embodiment, the composition according to the invention is an additive for a paint, glaze, varnish and/or car care formulation comprising at least one polysiloxane (i) according to the invention and an organic solvent. In this case, the composition preferably contains 0.1-99.9% by weight, particularly preferably 0.5-99% by weight and most preferably 10-90% by weight, of component (i) based on its total mass.

In car care and paint compositions, component (i) can be present at 0.1-5 wt. % relative to the total mass.

The use according to the invention for finishing a textile substrate is preferred. In particular, the textile substrate can be a woven fabric, knitted fabric, non-woven fabric, fibre and/or leather or a mixed product thereof. According to the invention, the textile substrate may comprise natural fibres, in particular cotton and/or wool, and/or synthetic fibres, in particular viscose, polyester, polyamide and/or polyacrylonitrile.

Emulsions or aqueous dilutions of these emulsions, also known as liquors, are preferably used to finish a textile substrate.

Surprisingly, it has been shown that the polysiloxanes according to the invention enable homogeneous application under all conditions when treating substrates. Thanks to the high emulsion stability, uniform finishing of the substrates is possible even under conditions that otherwise have a destabilising effect on emulsions, for example at high pH values, in the presence of salts, in the presence of anions and/or under strong shear forces.

In a preferred embodiment, the polysiloxane or composition according to the invention can be used to improve the soft handle of the textile substrate. Surprisingly, it has been shown that finishing with polysiloxanes according to the invention produces an excellent soft handle in treated textiles without impairing hydrophilicity. It has also been shown that the fabric treated in this way is stable against thermal and/or phenolic yellowing.

The use of the invention for finishing dyed or optically brightened goods offers a particular advantage. The finishing can also be carried out in the same jet dyeing machines in which the fabric was dyed or optically brightened. Surprisingly, it has been shown that finishing with polysiloxanes or compositions according to the invention does not impair the respective colouring or optical brightening and at the same time significantly improves the soft handle of the fabric.

In a further preferred embodiment, the polysiloxane or composition according to the invention can be used to improve the wetting, spreading and/or levelling properties and/or the foaming behaviour of paint, glaze, varnish and/or car care formulations. By using the polysiloxane according to the invention, depending on the application in these formulations, the surface tension can be lowered, whereby the formulation can run more evenly and/or wet substrates better and whereby cratering can also be avoided. In addition, the presence of the polysiloxane according to the invention in the formulation can increase the surface smoothness of the treated materials. In car care products, the composition enables, among other things, so-called sheeting, i.e. spreading of (rain) water on the treated surfaces. This accelerates the break-up of the water film, allowing the water to run off more easily and accelerating drying. Furthermore, the polysiloxanes according to the invention can have a deaerating and/or defoaming effect.

A further aspect of the invention relates to a substrate, in particular a textile substrate, which is treated with polysiloxanes according to the invention. Preferably, the substrate according to the invention contains 0.04-2.4% by weight, particularly preferably 0.08-1.2% by weight, of polysiloxanes according to the invention, based on the total mass of the textile substrate. The substrate is preferably one of the above-mentioned substrates.

In a particularly preferred embodiment, the substrate is a textile substrate as described above.

In an alternative embodiment, the substrate is a metallic substrate.

Another aspect of the invention relates to a process for treating a substrate comprising the steps of
(i) providing a substrate,
(ii) applying a polysiloxane according to the invention or a composition according to the invention to the substrate, and
(iii) optionally treating the substrate obtained after step (ii) at elevated temperature.

The substrate in steps (i)-(iii) is preferably one of the substrates mentioned above. In a particularly preferred embodiment, the substrate is a textile substrate as described above.

The application of the polysiloxane according to the invention or the composition according to the invention to the substrate in step (ii) can preferably be carried out by padding, spraying, brushing, dipping, patting and/or by exhaustion processes. For example, a textile substrate can be finished with a polysiloxane according to the invention or a composition according to the invention by exhaustion in a jet.

In a preferred embodiment, water is removed in step (iii) of the process according to the invention, preferably at a temperature of 110-150° C., possibly under reduced pressure.

The following examples serve to explain the present invention in more detail, but without limiting it.

### EXAMPLES

### Example 1 (not According to the Invention)

According to EP 0 294 642 A2, Example 3, 56.8 g (200 mmol) of lauryl (dimethylaminopropyl) amide were mixed with 80.0 g of H₂O and 12.0 g (200 mmol) of glacial acetic acid were added at 20° C. After 30 min, the reaction was heated to 50° C. and 590 g (100 mmol) of an epoxysiloxane with an epoxide content of 0.338 mol/kg and an average chain length of 75 was dropwise added. After addition of 200 ml isopropanol, stirring was continued for 6 h under reflux. The H₂O/isopropanol mixture was distilled off at 100° C. and 0.2 bar. 140 g of butyl diglycol were added, yielding a slightly yellow organopolysiloxane.

### Example 2 (According to the Invention)

500 g of a laterally Si—H-modified poly(dimethylsiloxane-co-methylhydrosiloxane)s with 0.089 wt. % Si-bound hydrogen (corresponding to 443 mmol Si—H) and an average chain length of 75 were added within 60 minutes to a solution of 28.3 mg Karstedt catalyst in 65.7 g (575 mmol) allyl glycidyl ether, which had previously been tempered to 135° C. After removal of the excess allyl glycidyl ether by distillation, 44.4 g (443 mmol) of N-methylpiperazine was slowly added at 135° C. to give a clear, slightly yellowish organopolysiloxane (intermediate A).

76.5 g of the intermediate A obtained (corresponding to 114 mmol tert. nitrogen) was heated to 35° C. together with 14.0 g butyl diglycol. At this temperature, 6.46 g (57.0 mmol) of a 30% aqueous hydrogen peroxide solution was added with stirring. After the end of the exotherm reaction, stirring was continued for 6 h at 75° C., whereby a slightly yellowish organopolysiloxane was obtained.

### Example 3 (According to the Invention)

76.5 g of the intermediate A from Example 2 (corresponding to 114 mmol tert. nitrogen) was heated to 35° C. together with 8.50 g of butyl diglycol. At this temperature, 12.9 g (114 mmol) of a 30% aqueous hydrogen peroxide solution was added with stirring. After the end of the exotherm reaction, stirring was continued for 6 h at 75° C. to give a slightly yellowish organopolysiloxane.

### Example 4 (According to the Invention)

500 g of an α,ω-dihydrogenpolydimethylsiloxane with 0.035 wt. % Si-bonded hydrogen (corresponding to 176 mmol Si—H) and an average chain length of 75 were added within 60 min to a solution of 26.3 mg Karstedt catalyst in 26.1 g (229 mmol) allyl glycidyl ether, which was previously tempered to 135° C. After removal of the excess allyl glycidyl ether by distillation, 33.0 g (176 mmol) of bis[3-(dimethylamino)propyl]amine was slowly added at 135° C. to give a yellowish organopolysiloxane (Intermediate B).

76.5 g of intermediate B (corresponding to 48.7 mmol tert. nitrogen) was heated to 35° C. together with 13.0 g butyl diglycol. At this temperature, 5.52 g (48.7 mmol) of a 30% aqueous hydrogen peroxide solution was added with stirring. After the end of the exotherm reaction, stirring was continued for 6 h at 75° C., whereby a slightly yellowish organopolysiloxane was obtained.

### Example 5 (According to the Invention)

7.04 g (74.5 mmol) chloroacetic acid was dissolved in 5.00 g H₂O, 10.0 g butylglycol. To this solution, 5.96 g (74.5 mmol) of 50% sodium hydroxide solution was added with stirring. After stirring for 15 min, 100 g of the intermediate A from example 2 (corresponding to 149 mmol tert. nitrogen) was added and the mixture was stirred for 4 h at 75° C., yielding a slightly yellowish organopolysiloxane.

### Example 6 (According to the Invention)

5.41 g (57.3 mmol) of chloroacetic acid was dissolved in 6.00 g of H₂O, 12.0 g of butylglycol. To this solution, 4.58 g (57.3 mmol) of 50% sodium hydroxide solution was added with stirring. After stirring for 15 min, 100 g of the intermediate B from example 4 (corresponding to 63.6 mmol tert. nitrogen) was added and the mixture was stirred for 4 h at 75° C., yielding a slightly yellowish organopolysiloxane.

### Example 7 (According to the Invention)

500 g of an α,ω-dihydrogenpolydimethylsiloxane with 0.035 wt. % Si-bonded hydrogen (corresponding to 176 mmol Si—H) and an average chain length of 75 were added within 60 min to a solution of 26.3 mg Karstedt catalyst in 26.1 g (229 mmol) allyl glycidyl ether, which was previously tempered to 135° C. After removal of the excess allyl glycidyl ether by distillation, 33.0 g (176 mmol) of bis[3-(dimethylamino)propyl]amine was slowly added at 135° C. The catalyst was then cooled to 50° C. It was then cooled to 50° C., 896 mg of 1,4-diazabicyclo[2.2.2]octane and 38.1 g (172 mmol) of isophorone diisocyanate were added and the mixture was stirred at 70° C. until no NCO band was visible in the IR spectrum, yielding a yellowish organopolysiloxane (polysiloxane adduct C).

75.1 g of the polysiloxane adduct C (corresponding to 46.6 mmol tert. nitrogen) was heated to 75° C. together with 5.00 g H₂O, 10.0 g butyl glycol, 2.64 g (28.0 mmol) chloroacetic acid and 2.24 g (28.0 mmol) 50% sodium hydroxide solution. The mixture was stirred at 75° C. for 4 h, yielding a slightly yellowish organopolysiloxane.

### Emulsion Examples

### General Emulsification Instructions:

The specified amount of emulsifier was added to the organopolysiloxane to be emulsified at room temperature and stirred using a wall-mounted anchor stirrer until a homogeneous mixture was obtained. H₂O was added to this mixture in portions and stirred until the entire portion of water was absorbed.

| | Emulsion | Emulsion | Emulsion | Emulsion | Emulsion | Emulsion | Emulsion |
|---|---|---|---|---|---|---|---|
| | E1 | E2 | E3 | E4 | E5 | E6 | E7 |
| Component | quantity | quantity | quantity | quantity | quantity | quantity | quantity |
| Organopolysiloxane | 20.0% | | | | | | |
| from example 1 | | | | | | | |
| Organopolysiloxane | | 20.0% | | | | | |
| from example 2 | | | | | | | |
| Organopolysiloxane | | | 20.0% | | | | |
| from example 3 | | | | | | | |
| Organopolysiloxane | | | | 20.0% | | | |
| from example 4 | | | | | | | |
| Organopolysiloxane | | | | | 20.0% | | |
| from example 5 | | | | | | | |
| Organopolysiloxane | | | | | | 20.0% | |
| from example 6 | | | | | | | |
| Organopolysiloxane | | | | | | | 20.0% |
| from example 7 | | | | | | | |
| Isotridecyl alcohol + | 8.5% | 8.5% | 8.5% | 8.5% | 8.5% | 8.5% | 8.5% |
| 6 EO | | | | | | | |
| H₂O | 71.5% | 71.5% | 71.5% | 71.5% | 71.5% | 71.5% | 71.5% |

### Application Examples

Soft Grip Assessment Sections of cotton terry cloth that had not been optically brightened were finished with an aqueous liquor containing 20 g/l of the emulsions prepared according to the examples, adjusted to pH 5 with 60% acetic acid, in a Mathis Labomat for 20 minutes at 40° C. and at a liquor ratio of 1:10. The excess liquor was then squeezed out with a laboratory padder at 3 bar, followed by drying at 140° C. for 2 minutes. The circulation speed was 45 rpm.

The grip character of the test fabrics treated with the emulsions was then assessed. This is subject to individually different, subjective criteria. Nevertheless, in order to obtain meaningful results, an assessment by at least 5 test persons is required. The results were analysed using statistical methods, with grade 1 representing the softest, most pleasant grip and grade 3 the hardest, least soft and most unpleasant grip within the test series.

| | Assessment |
|---|---|
| Emulsion example E1 | 2.8 |
| (not according to the invention) | |
| Emulsion example E2 | 1.2 |
| Emulsion example E3 | 2.0 |
| Emulsion example E4 | 2.2 |
| Emulsion example E5 | 1.3 |
| Emulsion example E6 | 1.7 |
| Emulsion example E7 | 1.1 |

### Hydrophilicity

The hydrophilicity of the cotton terry fabric finished for soft handle evaluation was assessed according to the TEGEWA drop test (Melliand Textilberichte 68 (1987), 581-583).

| | Soaking time [s] |
|---|---|
| Emulsion example E1 | 2 |
| (not according to the invention) | |
| Emulsion example E2 | 1.5 |
| Emulsion example E3 | 1 |
| Emulsion example E4 | 0.5 |
| Emulsion example E5 | 1.5 |
| Emulsion example E6 | 1 |
| Emulsion example E7 | 1 |

### Anion Stability

100 ml of the emulsion to be tested was prepared in water at a concentration of 40 g/I in each of two beakers. 100 ml of a solution of 4 g/L VEROLAN® NEW (organic dispersant with polyacrylates and alkyl phosphonate, anion-active) are added to the first beaker. In the second beaker, 100 ml of a solution of 12 g/L RUCO-BLANC® AMA (whitener, stilbene derivative, anion-active) was added. The liquors were adjusted to pH 5 with 60% acetic acid.

The evaluation was carried out after six hours of standing time, according to the following grading:
1 liquor is clear
2 liquor is cloudy or “slightly cloudy”
3 The liquor is flocculent or has a sediment that can be stirred back in (does not flocculate again within 1 minute)
4 Large flake formation or sediment that can no longer be stirred in
5 Oily deposits on the surface of the liquor or beaker

The test is deemed to have been passed if the assessment is no worse than “3”.

| | Assessment |
|---|---|
| | after 6 hours* |
| Emulsion example E1 | 5/4 |
| (not according to the invention) | |
| Emulsion example E2 | 3/3 |
| Emulsion example E3 | 2/1 |
| Emulsion example E4 | 3/2 |
| Emulsion example E5 | 2/2 |
| Emulsion example E6 | 2/2 |
| Emulsion example E7 | 2/1 |

*The left-hand value of the assessment refers to the stability in the presence of VEROLAN ® NEW, the right-hand value to the stability in the presence of RUCO-BLANC ® AMA.

### Thermal Yellowing

Sections of a bleached, not optically brightened cotton modal knitted fabric were impregnated with an aqueous liquor containing 20 g/l of the emulsions prepared according to the examples and 0.5 g/I 60% acetic acid on a lab foulard with a wet absorption of 80%, dried at 120° C. for 2 minutes and then heat-set at 170° C. for 2 minutes. The whiteness of the samples was then measured according to Ganz (Applied Optics 15 (1976) 9, 2039-2058) on the “texflash 2000” whiteness measuring device from “datacolor international” (Switzerland).

| | Whiteness according to Ganz |
|---|---|
| Unfinished textile | 231 |
| Emulsion example E1 | 231 |
| Emulsion example E2 | 229 |
| Emulsion example E3 | 230 |
| Emulsion example E4 | 232 |
| Emulsion example E5 | 230 |
| Emulsion example E6 | 232 |
| Emulsion example E7 | 231 |

The preparations according to the invention do not cause yellowing of the textile substrate. The degree of whiteness of the substrates treated with the preparations according to the invention corresponds to that of the untreated textile.

### Phenolic Yellowing

Sections of a bleached, not optically brightened cotton modal knitted fabric were impregnated with an aqueous liquor containing 40 g/l of the emulsions prepared according to the examples and 0.5 g/l of 60% acetic acid on a lab foulard with a wet absorption of 80% and then dried at 120° C. for 2 minutes. The yellowing was then assessed using the sandwich test (DIN EN ISO 105-X18).

Each test sample and the control fabric are placed individually between a folded test paper between two glass plates in a horizontal stack. The stack of plates, test papers, test samples and control tissue is then packed airtight and incubated in a heating cabinet at 50° C. for 16 hours.

After opening the package, possible colour changes are immediately evaluated using the grey scale on a scale of 1-5 in accordance with ISO 105-A01.

The higher the value on the grey scale, the less yellowed the textile is:

| | Assessment |
|---|---|
| Emulsion example E1 | 3-4 |
| (not according to the invention) | |
| Emulsion example E2 | 4 |
| Emulsion example E3 | 4-5 |
| Emulsion example E4 | 4-5 |
| Emulsion example E5 | 4 |
| Emulsion example E6 | 4-5 |
| Emulsion example E7 | 4-5 |

### Jet Stability

In a beaker, 400 mL of liquor containing 4 g/I sodium sulphate and 5 g/L of the emulsion to be tested in water was adjusted to pH 4.5 with 60% acetic acid. The aqueous liquor was then heated to 40° C. and stirred for twenty minutes at this temperature with an inclined blade stirrer at two thousand rounds per minute. At the end of this time, the stirrer was switched off and the liquid was assessed for separation after a rest period of one hour. This test is intended to simulate the mechanical forces of a jet process in the presence of textile auxiliaries remaining on the textile from previous finishing steps.

| | Result |
|---|---|
| Emulsion example E1 | Silicone deposits on the edge |
| (not according to the invention) | and surface |
| Emulsion example E2 | Cloudy liquor, no deposits |
| Emulsion example E3 | Slightly cloudy liquor, no deposits |
| Emulsion example E4 | Slightly cloudy liquor, no deposits |
| Emulsion example E5 | Cloudy liquor, no deposits |
| Emulsion example E6 | Slightly cloudy liquor, no deposits |
| Emulsion example E7 | Slightly cloudy liquor, no deposits |

The following items summarise the invention:
1. A polysiloxane of the general formula A

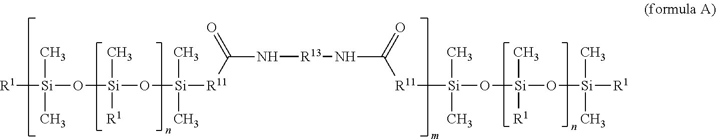

wherein
   R¹ is independently of each other
      methyl,

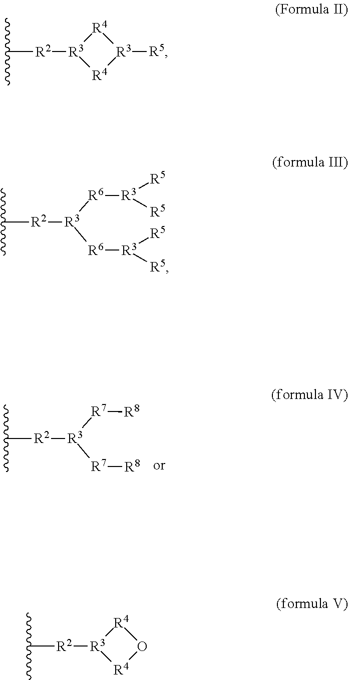

with the proviso that in formula A at least one R¹ corresponds to one of the formulae II-V,
   R² is independently of each other

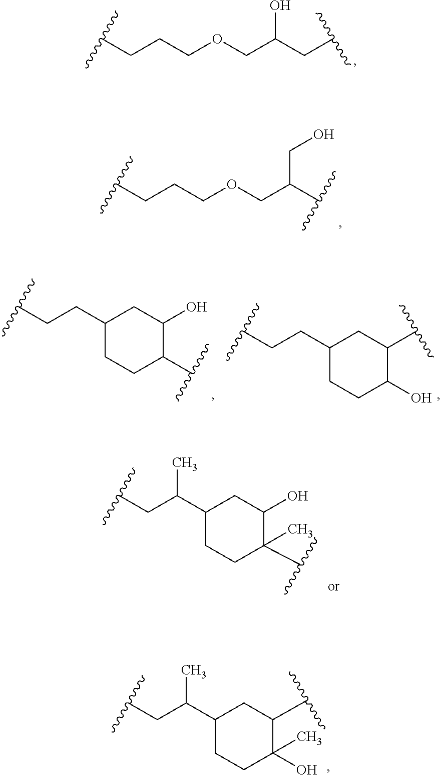 [SMILES: *CCCOCC(O)C* ; *CCCOCC(*)CO ; *CCC1CCC(*)C(O)C1 ; *CCC1CCC(O)C(*)C1 ; *CC(C)C1CCC(*)(C)C(O)C1 ; *CC(C)C1CCC(C)(O)C(*)C1]

R³ is independently of each other

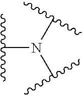 [SMILES: *N(*)*]

or a zwitterionic group selected from

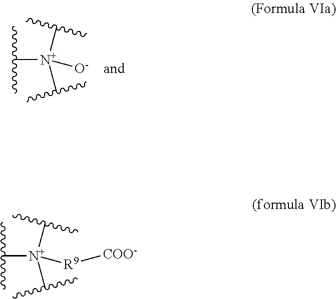

with the proviso that at least one R³ in formula A is a zwitterionic group,
   R⁴ is independently of each other an unbranched or branched C₁₋₇-alkylene, preferably an unbranched C₁₋₅-alkylene, particularly preferably —(CH₂)₂—,
   R⁵ is independently of each other a branched or unbranched C₁₋₁₈-alkyl, preferably an unbranched C₁₋₈-alkyl, particularly preferably methyl,
   R⁶ is independently of each other an unbranched C₂-s-alkylene, preferably
      (CH₂)₂— or —(CH₂)₃—,
   R⁷ is independently of each other an unbranched or branched C₁₋₁₈-alkylene, preferably an unbranched C₁₋₈-alkylene, particularly preferably —(CH₂)₂— or methylene,
   R³ is independently H or OH,
   R⁹ is independently of each other is an unbranched or branched C₁₋₁₈-alkylene, preferably an unbranched C₁₋₈-alkylene, particularly preferably methylene,
   R¹¹ is independently of each other

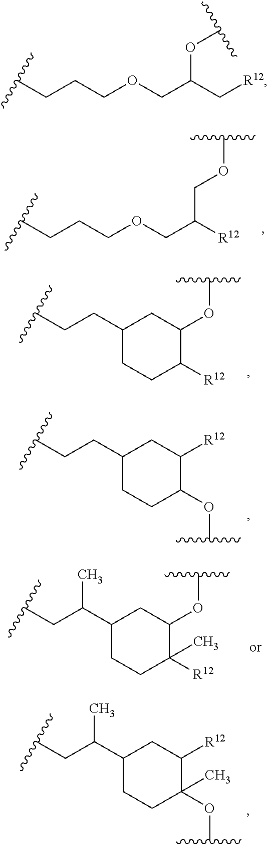

R¹² is independently of each other

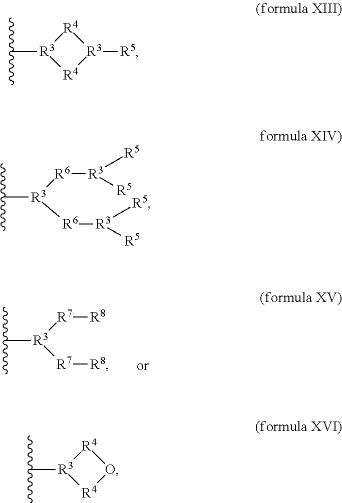

R¹³ is independently of each other an aliphatic or cyclic C₁₋₁₈-alkylene or arylene, in each case optionally substituted by C₁₋₈-alkyl or benzyl, preferably unbranched C₁₋₈-alkylene, in particular —(CH₂)₄—, —(CH₂)₆—,

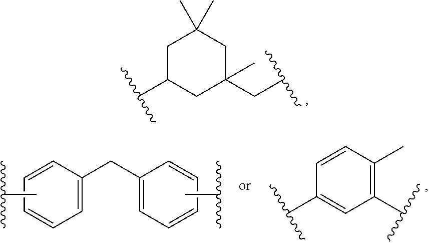

n is an integer from 20-2,000, preferably 40-1,000, particularly preferably 40-180, and
   m is 0 or an integer greater than 0, preferably 0 or 1-2,000, particularly preferably 0 or 1-55.
2. Polysiloxane according to item 1, wherein 0-99.9%, preferably 50-99.9%, more preferably 80-99.9% and particularly preferably 90-99.9% or 0-99.999%, preferably 50-99.999%, more preferably 80-99.999% and particularly preferably 90-99.999% of the R¹ substituents are methyl.
3. Polysiloxane according to any of the preceding items, wherein the two terminal R¹-substituents are methyl and at least one lateral R¹-substituent corresponds to one of the formulae II-V.
4. Polysiloxane according to any of items 1-2, wherein all lateral R¹-substituents are methyl and the two terminal R¹-substituents are selected from formulae II-V.
5. Polysiloxane according to any of the preceding items, wherein all R¹-substituents are selected from methyl and formula II.
6. Polysiloxane according to any of the preceding items, wherein 10-100%, preferably 40-99.9%, more preferably 50-95% and most preferably 60-80% of R³ in formula A are zwitterionic groups.
7. Polysiloxane according to any of the preceding items, wherein all zwitterionic groups are present as formula VIa.
8. Polysiloxane according to any of items 1-6, wherein all zwitterionic groups are present as formula VIb.
9. Polysiloxane according to any of the preceding items, wherein R² is preferably

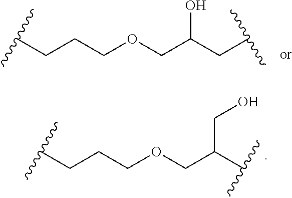 [SMILES: *CCCOCC(O)C* ; *CCCOCC(*)CO]

10. Polysiloxane according to any of the preceding items, wherein R¹¹ is

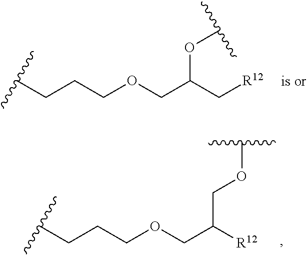

11. Polysiloxane according to item 10, wherein R¹² corresponds to one of the formulae XIII or XIV.
12. Polysiloxane according to any of the preceding items, wherein essentially all, in particular 90-99.999%, of the lateral R¹-substituents are methyl if m is greater than 0.
13. Polysiloxane according to any of items 1-9, having the general formula I

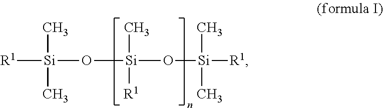

wherein
   R¹ is independently of each other
      methyl,

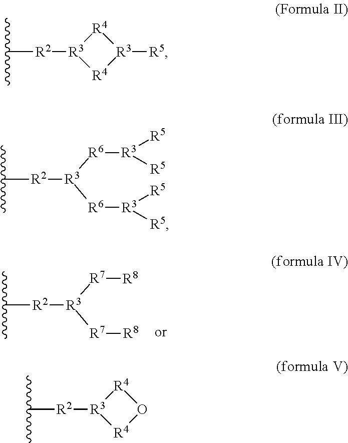

with the proviso that in formula I at least one R¹ corresponds to one of formulae II-V,
   R² is independently of each other

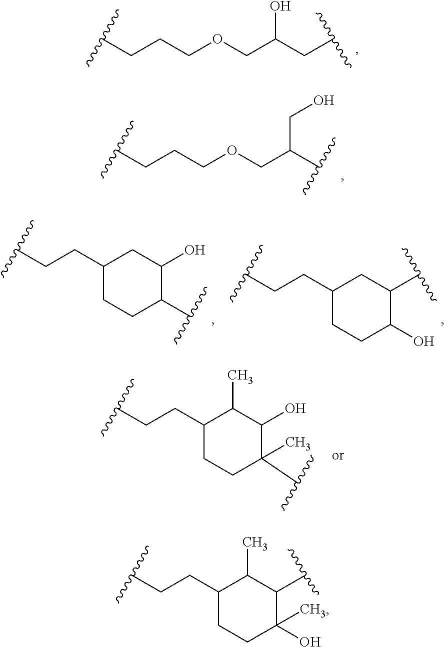 [SMILES: *CCCOCC(O)C* ; *CCCOCC(*)CO ; *CCC1CCC(*)C(O)C1 ; *CCC1CCC(O)C(*)C1 ; *CCC1CCC(*)(C)C(O)C1C ; *CCC1CCC(C)(O)C(*)C1C]

R³ is independently of each other

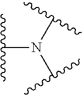 [SMILES: *N(*)*]

or a zwitterionic group selected from

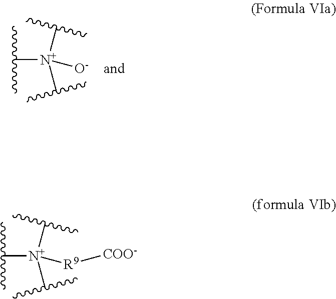

with the proviso that at least one R³ in formula I is a zwitterionic group,
   R⁴ is independently of each other an unbranched or branched C₁₋₇-alkylene, preferably an unbranched C₁₋₅-alkylene, particularly preferably —(CH₂)₂—,
   R⁵ is independently of each other a branched or unbranched C₁₋₁₈-alkyl, preferably an unbranched C₁₋₈-alkyl, particularly preferably methyl,
   R⁶ is independently of each other an unbranched C₂-s-alkylene, preferably —(CH₂)₂— or —(CH₂)₃—,
   R⁷ is independently of each other an unbranched or branched C₁₋₁₈-alkylene, preferably an unbranched C₁₋₈-alkylene, particularly preferably —(CH₂)₂— or methylene,
   R³ is independently H or OH,
   R⁹ is independently of each other an unbranched or branched C₁₋₁₈-alkylene, preferably an unbranched C₁₋₈-alkylene, particularly preferably methylene, and
   n is an integer from 20-2,000, preferably 40-1,000, particularly preferably 40-180.
14. A process for the preparation of polysiloxanes according to any of the preceding items, comprising
(a) providing a polysiloxane of the general formula VII

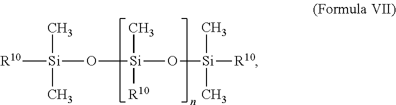

wherein
   R¹⁰ is independently of each other
      methyl,

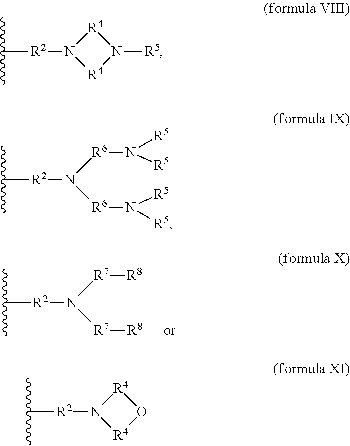

with the proviso that in formula VII at least one R¹⁰ corresponds to one of formulae VIII-XI,
(b) optionally reacting the polysiloxane of the general formula VII with a diisocyanate of the formula OCN—R¹³—NCO, and
(c) reacting the polysiloxane of the formula VII or the polysiloxane adduct obtained after step (b) with a reactant selected from a peroxide and/or a compound of the general formula XII

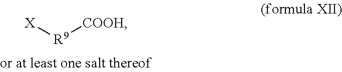

wherein X is a halogen, in particular Cl or Br,
   and wherein the peroxide is preferably hydrogen peroxide (H₂O₂), di-tert-butyl peroxide, tert-butyl hydroperoxide, tert-butyl peroxybenzoate, meta-chloroperbenzoic acid, dibenzoyl peroxide, diacetyl peroxide, peroxyacetic acid, dicumyl peroxide, cumene hydroperoxide, methyl ethyl ketone peroxide, sodium peroxide and/or barium peroxide and particularly preferably hydrogen peroxide (H₂O₂).
15. Process according to item 14, wherein the molar ratio between reactant and the tertiary amino groups in the polysiloxane of formula VII or in the polysiloxane adduct obtained after step (b) is 0.1:1-1:1, preferably 0.4:1-0.999:1, more preferably 0.5:1-0.95:1 and most preferably 0.6:1-0.8:1.
16. Process according to item 14 or 15, wherein in step b) the molar ratio of the isocyanate groups of the diisocyanate of the general formula OCN—R¹³—NCO to the isocyanate-reactive hydroxy groups of the polysiloxane of the general formula VII is from 0.1:1-1:1, more preferably from 0.4:1-0.999:1, particularly preferably from 0.5:1-0.95:1 and most preferably from 0.6:1-0.9:1.
17. Process according to any of items 14-16, wherein in step b) the diisocyanate of the general formula OCN—R¹³—NCO is selected from the group consisting of toluene-2,4-diisocyanate, 2,4′-diphenylmethane diisocyanate, 4,4′-diphenylmethane diisocyanate (MDI), higher-chain homologues of diphenylmethane diisocyanate (polymeric MDI), tetramethylene diisocyanate, hexamethylene diisocyanate and/or isophorone diisocyanate.
18. Process according to any of items 14-17, wherein in step b) and/or c) the reaction is carried out at 15-150° C., preferably at 20-105° C., more preferably at 25-95° C., even more preferably at 40-90° C. and particularly preferably at 70-85° C.
19. Process according to any of items 14-18, wherein step b) is carried out using a solvent or in the absence of a solvent, preferably in the absence of a solvent.
20. Process according to any of items 14-19, wherein step b) is carried out using a catalyst, in particular based on a tertiary amine, a bismuth compound and/or an organotin compound.
21. Process according to one of items 14-20, wherein the course of the reaction in step b) is monitored titrimetrically or by IR spectroscopy.
22. The process according to any of items 14-21, wherein the reaction in step c) is carried out in a solvent preferably comprising water and/or at least one organic solvent.
23. A composition comprising
   (i) at least one polysiloxane according to any of items 1-13 and
   (ii) a solvent, in particular water and/or an organic solvent.
24. Composition according to item 23, wherein the composition contains 0.005-99.9% by weight, preferably 5-99% by weight, particularly preferably 10-90% by weight of component (i), based on its total mass.
25. Composition according to any of items 23-24, further comprising
   (iii) at least one anionic, cationic, non-ionic or amphoteric emulsifier, preferably at least one nonionic emulsifier, particularly preferably ethoxylated products of aliphatic alcohols.
26. Composition according to item 25, wherein the emulsifier (iii) is present with 2-100 wt. %, preferably with 10-80 wt. %, particularly preferably with 20-70 wt. %. based on component (i)
27. Composition according to any of items 23-26, wherein the organic solvent is preferably from the group of mono- and polyfunctional alcohols and/or their ether compounds and/or their ester compounds.
28. Composition according to any of items 23-27, further comprising
   (iv) at least one additive, for example a dilutant, glycerol, urea and/or at least one acid and/or at least one softening agent, preferably an organomodified polysiloxane.
29. Composition according to any of items 23-28, which is present as an emulsion, preferably as an o/w emulsion.
30. A use of a polysiloxane according to any of items 1-13 or a composition according to any of items 23-29 for treating a substrate, in particular for finishing a textile substrate, or as an additive in paint, glaze, lacquer and/or car care formulations.
31. Use according to item 30, wherein the textile substrate is a fabric, knitted fabric, nonwoven, fibre and/or leather.
32. Use according to any of items 30-31, wherein the textile substrate contains natural fibres, in particular cotton and/or wool, and/or synthetic fibres, in particular viscose, polyester, polyamide and/or polyacrylonitrile.
33. Use according to any of the items 30-32 for improving the soft handle of the textile substrate.
34. Use according to item 30 for improving the wetting, spreading and/or levelling properties of paint, glaze, lacquer and/or car care formulations.
35. A substrate, in particular textile substrate, which is treated with polysiloxanes according to any of items 1-13.
36. Substrate according to item 35, which contains 0.04-2.4% by weight, preferably 0.08-1.2% by weight, of polysiloxanes based on the total mass of the textile substrate.
37. A process for treating a substrate comprising the steps of
   (iii) providing a substrate,
   (iv) applying the polysiloxane according to any of items 1-13 or a composition according to any of items 23-29 to the substrate, and
   (v) optionally treating the substrate obtained after step (ii) at elevated temperature.
38. Process for treating a substrate according to item 37, wherein step (ii) is carried out by foulard, spraying, brushing, dipping, padding and/or by exhaust.
39. Process for treating a substrate according to any of items 37-38, wherein in step (iii) water is removed, preferably at a temperature of 110-150° C.

1. A polysiloxane of general formula A 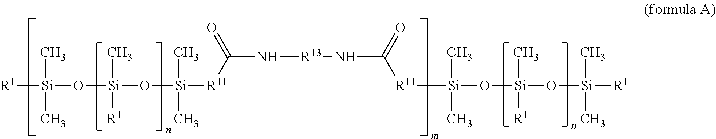
wherein
R¹ is independently of each other
methyl, 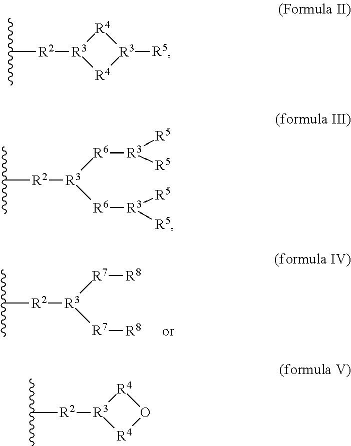
with the proviso that in formula A at least one R¹ corresponds to one of formulae II-V,
R² is independently of each other 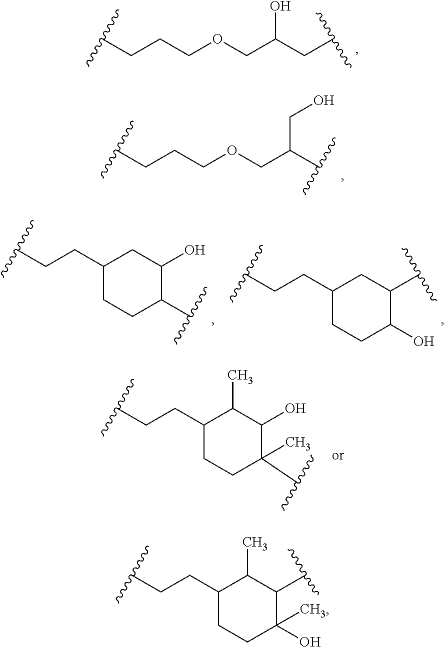 [SMILES: *CCCOCC(O)C* ; *CCCOCC(*)CO ; *CCC1CCC(*)C(O)C1 ; *CCC1CCC(O)C(*)C1 ; *CCC1CCC(*)(C)C(O)C1C ; *CCC1CCC(C)(O)C(*)C1C]
R³ is independently of each other 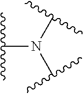 [SMILES: *N(*)*]
or a zwitterionic group selected from 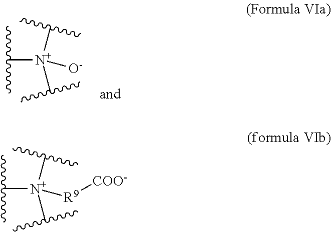
with the proviso that at least one R³ in formula A is a zwitterionic group,
R⁴ is independently of each other an unbranched or branched C₁₋₇-alkylene, preferably an unbranched C₁₋₅-alkylene, particularly preferably —(CH₂)₂—,
R⁵ is independently of each other a branched or unbranched C₁₋₁₈-alkyl, preferably an unbranched C₁₋₈-alkyl, particularly preferably methyl,
R⁶ is independently of each other an unbranched C₂-s-alkylene, preferably
—(CH₂)₂— or —(CH₂)₃—,
R⁷ is independently of each other an unbranched or branched C₁₋₁₈-alkylene, preferably an unbranched C₁₋₈-alkylene, particularly preferably —(CH₂)₂— or methylene,
R⁸ is independently H or OH,
R⁹ is independently of each other an unbranched or branched C₁₋₁₈-alkylene, preferably an unbranched C₁₋₈-alkylene, particularly preferably methylene,
R¹¹ is independently of each other 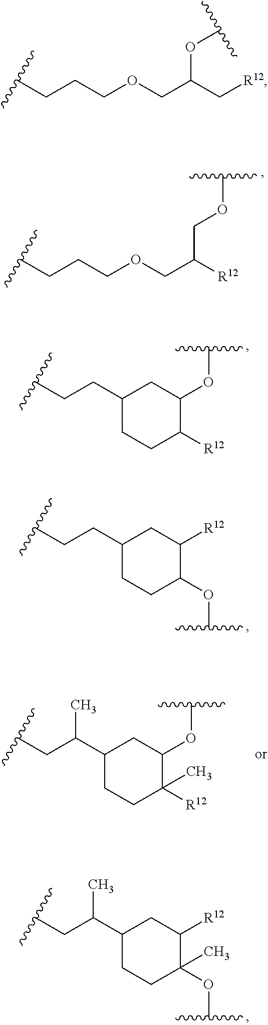
R¹² is independently of each other 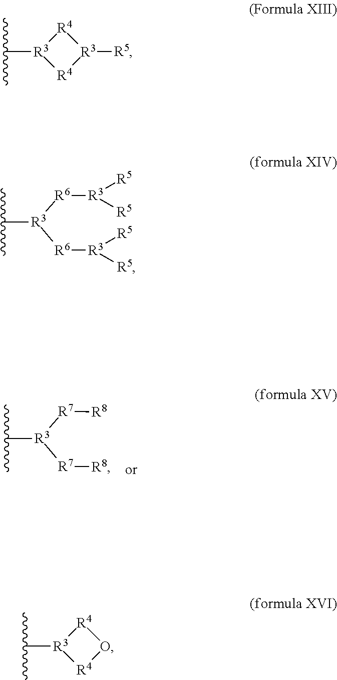
R¹³ is independently of each other an aliphatic or cyclic C₁₋₁₈-alkylene or arylene, in each case optionally substituted by C₁₋₈-alkyl or benzyl, preferably unbranched C₁₋₈-alkylene, in particular —(CH₂)₄—, —(CH₂)₆—, 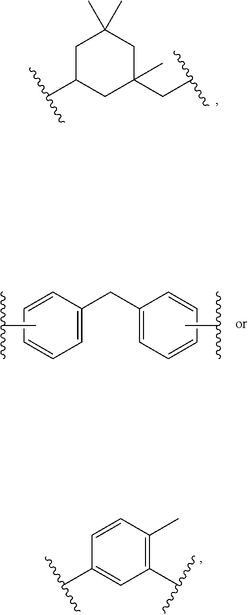
n is an integer from 20-2,000, preferably 40-1,000, particularly preferably 40-180, and
m is 0 or an integer greater than 0, preferably 0 or 1-2,000, more preferably 0 or 1-55.

2. The polysiloxane according to claim 1, wherein 0-99.9%, preferably 50-99.9%, more preferably 80-99.9% and particularly preferably 90-99.9% or 0-99.999%, preferably 50-99.999%, more preferably 80-99.999% and particularly preferably 90-99.999% of the R¹ substituents are methyl.

3. The polysiloxane according to claim 1, wherein the two terminal R¹ substituents are methyl and at least one lateral R¹ substituent corresponds to one of the formulae II-V, or
all lateral R¹ substituents are methyl and the two terminal R¹ substituents are selected from formulae II-V.

4. The polysiloxane according to claim 1, wherein all R¹ substituents are selected from methyl and formula II, and/or
wherein R² is 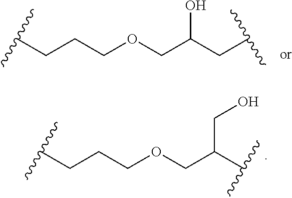 [SMILES: *CCCOCC(O)C* ; *CCCOCC(*)CO]
and/or
wherein R¹¹ is 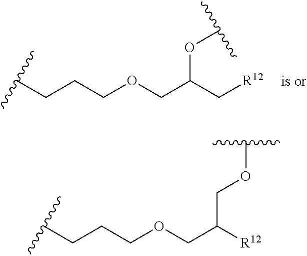
is and/or
wherein R¹² corresponds to one of formulae XIII or XIV.

5. The polysiloxane according to claim 1, wherein 10-100%, preferably 40-99.9%, more preferably 50-95% and most preferably 60-80% of R³ in formula A are zwitterionic groups, and/or
all zwitterionic groups are present as formula VIa or all zwitterionic groups are present as formula VIb.

6. The polysiloxane according to claim 1, having the general formula I 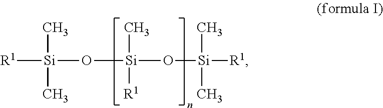
wherein
R¹ is independently of each other
methyl, 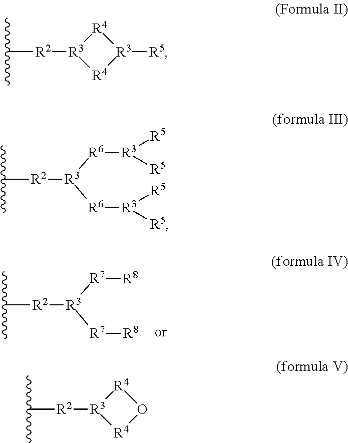
with the proviso that in formula I at least one R¹ corresponds to one of formulae II-V,
R² is independently of each other 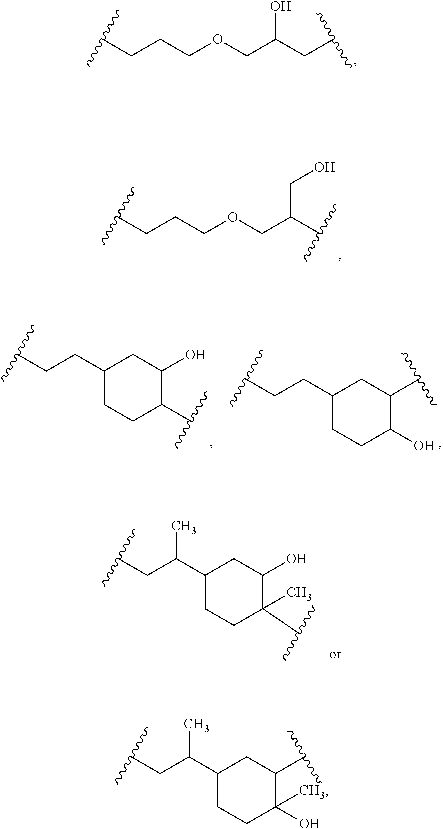 [SMILES: *CCCOCC(O)C* ; *CCCOCC(*)CO ; *CCC1CCC(*)C(O)C1 ; *CCC1CCC(O)C(*)C1 ; *CC(C)C1CCC(*)(C)C(O)C1 ; *CC(C)C1CCC(C)(O)C(*)C1]
R³ is independently of each other 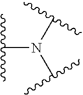 [SMILES: *N(*)*]
or a zwitterionic group selected from 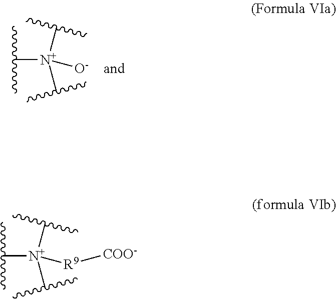
with the proviso that at least one R³ in formula I is a zwitterionic group,
R⁴ is independently of each other an unbranched or branched C₁₋₇-alkylene, preferably an unbranched C₁₋₅-alkylene, particularly preferably —(CH₂)₂—,
R⁵ is independently of each other a branched or unbranched C₁₋₁₈-alkyl, preferably an unbranched C₁₋₈-alkyl, particularly preferably methyl,
R⁶ is independently of each other an unbranched C₂-s-alkylene, preferably —(CH₂)₂— or —(CH₂)₃—,
R⁷ is independently of each other an unbranched or branched C₁₋₁₈-alkylene, preferably an unbranched C₁₋₈-alkylene, particularly preferably —(CH₂)₂— or methylene,
R³ is independently H or OH,
R⁹ is independently of each other an unbranched or branched C₁₋₁₈-alkylene, preferably an unbranched C₁₋₈-alkylene, particularly preferably methylene, and
n is an integer from 20-2,000, preferably 40-1,000, particularly preferably 40-180.

7. A process for the preparation of the polysiloxane according to claim 1, comprising the steps of
(a) providing a polysiloxane of the general formula VII 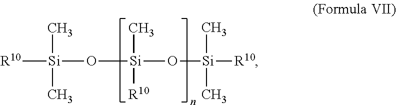
wherein
R¹⁰ is independently of each other
methyl, 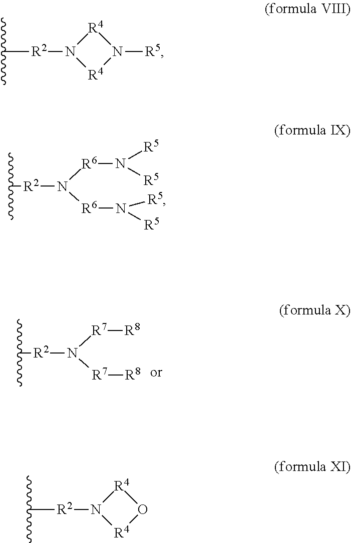
with the proviso that in formula VII at least one R¹⁰ corresponds to one of formulae VIII-XI,
(b) optionally reacting the polysiloxane of the general formula VII with a diisocyanate of the formula OCN—R¹³—NCO, and
(c) reacting the polysiloxane of the formula VII or the polysiloxane adduct obtained after step (b) with a reactant selected from a peroxide and/or a compound of the general formula XII 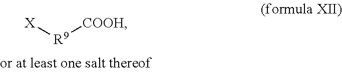
wherein X is a halogen, in particular Cl or Br,
and wherein the peroxide is preferably hydrogen peroxide (H₂O₂), di-tert-butyl peroxide, tert-butyl hydroperoxide, tert-butyl peroxybenzoate, meta-chloroperbenzoic acid, dibenzoyl peroxide, diacetyl peroxide, peroxyacetic acid, dicumyl peroxide, cumene hydroperoxide, methyl ethyl ketone peroxide, sodium peroxide and/or barium peroxide and particularly preferably hydrogen peroxide (H₂O₂),
wherein the molar ratio between reactant and the tertiary amino groups in the polysiloxane of formula VII or in the polysiloxane adduct obtained after step (b) is preferably 0.1:1-1:1, more preferably 0.4:1-0.999:1, more preferably 0.5:1-0.95:1 and most preferably 0.6:1-0.8:1.

8. The process according to claim 7, wherein in step b) the molar ratio of the isocyanate groups of the diisocyanate of the general formula OCN—R¹³—NCO to the isocyanate-reactive hydroxy groups of the polysiloxane of the general formula VII is from 0.1:1-1:1, more preferably from 0.4:1-0.999:1, particularly preferably from 0.5:1-0.95:1 and most preferably from 0.6:1-0.9:1, and/or
wherein in step b) the diisocyanate of the general formula OCN—R¹³—NCO is selected from the group consisting of toluene-2,4-diisocyanate, 2,4′-diphenylmethane diisocyanate, 4,4′-diphenylmethane diisocyanate (MDI), higher-chain homologues of diphenylmethane diisocyanate (polymeric MDI), tetramethylene diisocyanate, hexamethylene diisocyanate and/or isophorone diisocyanate.

9. Process according to claim 7, wherein in step c) the reaction is carried out in a solvent which preferably comprises water and/or at least one organic solvent, and/or
wherein step b) is carried out using a solvent or in the absence of a solvent, and/or
wherein step b) and/or step c) is carried out at 15-150° C., more preferably at 20-105° C., even more preferably at 25-95° C., even more preferably at 40-90° C. and particularly preferably at 70-85° C.

10. A composition comprising
(i) the polysiloxane according to claim 1 and
(ii) a solvent, in particular water and/or an organic solvent, which is preferably from the group of mono- and polyfunctional alcohols and/or their ether compounds and/or their ester compounds,
(iii) optionally at least one anionic, cationic, non-ionic or amphoteric emulsifier, preferably at least one non-ionic emulsifier, particularly preferably ethoxylated products of aliphatic alcohols,
wherein the emulsifier (iii) is present preferably with 2-100 wt. %, more preferably with 10-80 wt. %, particularly preferably with 20-70 wt. %, based on component (i), and/or
(iv) optionally at least one additive, for example a dilutant, glycerol, urea and/or at least one acid and/or at least one softening agent, preferably an organomodified polysiloxane,
wherein the composition preferably contains 0.005-99.9% by weight, more preferably 5-99% by weight, particularly preferably 10-90% by weight of component (i), based on its total mass.

11. The composition according to claim 10, which is present as an emulsion, preferably as an o/w emulsion.

12. A process comprising using the polysiloxane according to claim 1 for treating a substrate, in particular for finishing a textile substrate, wherein the textile substrate is preferably a woven fabric, knitted fabric, non-woven fabric, fibre and/or leather and particularly preferably contains natural and/or synthetic fibres, or
as an additive in paint, glaze, lacquer and/or car care formulations.

13. The process according to claim 12, wherein the polysiloxane is used for improving the soft handle of the textile substrate, and/or
for improving the wetting, spreading and/or levelling properties of paint, glaze, lacquer and/or car care formulations.

14. A substrate, in particular textile substrate, which is treated with a polysiloxane according to claim 1, wherein the textile substrate preferably contains 0.04-2.4 wt. %, particularly preferably 0.08-1.2 wt. % of polysiloxanes based on its total mass.

15. A process for treating a substrate comprising the steps of
(i) providing a substrate,
(ii) applying the polysiloxane according to claim 1 to the substrate, and
(iii) optionally treating the substrate obtained after step (ii) at an elevated temperature, preferably to remove water, in particular at a temperature of 110-150° C.,
wherein step (ii) is preferably carried out by foulard, spraying, brushing, dipping, padding and/or by exhaust.
